(19) United States
(12) Patent Application Publication
(10) Pub. No.: US 2012/0297633 A1
(43) Pub. Date: Nov. 29, 2012

(54) HAND HELD, ELECTRICALLY POWERED, WOOD PLANERS

(76) Inventor: Peter Atlagic, West Footscray (AU)

(21) Appl. No.: 13/123,968

(22) PCT Filed: Oct. 13, 2009
(86) PCT No.: PCT/AU09/01349

§ 371 Date: Aug. 16, 2012

(30) Foreign Application Priority Data
Oct. 13, 2008 (AU) 2008905304

(51) Int. Cl. B27C 1/10

(52) U.S. Cl. 30/475

(57) ABSTRACT

A hand held, electrically powered, wood planer is able to shave small amounts of wood stock from a work piece, and has a housing in which is located an electric motor and a cylindrical planing tool rotatably mounted for rotation about a horizontal axis. The planing tool is supplied with power from the motor to cause its rotation, and has a minor portion which projects from an opening of the housing. In use, the minor portion of the planing tool impinges on a work piece located in a confined space and, with numerous passes against the work piece, shaves a required thickness of the wood stock. The planer also has a height adjustable base which, when operated, will adjust the distance to which the minor portion of the planing tool projects from the opening for varying the required thickness of shaved wood stock.

### TECHNICAL FIELD

The present invention relates to electric planers and, in particular, to improvements in hand held, electrically powered, wood planers for shaving small amounts of wood stock from a door, frame or other work piece as may be required for small adjustments in thickness. More particularly, the present invention relates to an electric planer having a height adjustable base adapted to adjust the distance to which a minor portion of a cylindrical planing tool projects from an opening in a housing of the planar so as to allow for variation of the required thickness of shaved wood stock from, say, the bottom of a door that is still on its hinges.

Although the background, objects and preferred embodiments of the invention will be hereinafter described with reference to a hand held, electrically powered, wood planer for shaving wood stock of, say, 15 to 20 mm thickness from a wooden structure that may be located in a confined space or near an obstruction in a room under renovation or construction, it is to be understood that the invention is not limited thereto but has wider application. For example, the wood planer may be used for shaving wood stock of greater thickness from any work pieces to which a tradesman has access. Also, the planar may be used on all kinds of wood and wood based products, such as fibre board and chip board, that are amenable to planing.

It is to be understood that the terminology employed herein is for the purpose of description only and should not be regarded as limiting. For instance, the terms “comprising” or “comprises” are to be understood as meaning “including”, unless otherwise stated. Also, the term “electrically powered” is to be understood as meaning either wired mains powered or portable (wireless) battery powered.

### BACKGROUND ART

Hand held, electrically powered, wood planers are well known in the art. Conventionally, such wood planers comprise a housing in which is located an electric motor and a major portion of a cylindrical rotatable planing tool to which power can be transmitted from the motor. A rectangular opening is provided at the bottom of the housing near the middle of the planer for allowing a minor portion of the planing tool to project therefrom and, in use, to impinge on a wooden structure or work piece.

The planer is held in a manner, when operated, whereby the tool rotates on a horizontal axis and numerous passes against a work piece are made until a required thickness or amount of wood stock has been shaved or planed away. Such wood planers are effective when operating in open, unobstructed spaces, but are ill suited for operating in confined spaces or near an obstruction, and where small amounts of wood stock may need to be shaved.

Presently, when it is necessary to shave wood stock from the top or side of a door for a proper fit with the door frame, a tradesman using a conventional wood planer will need to firstly remove the door and operate the planer in more open space, before rehanging the door. This task is laborious and time consuming.

Furthermore, for shaving wood stock from a bowed framing stud located near an obstruction, conventional wood planers may not be as effective as a hammer and a chisel. This may be particularly important when trying to bring the inside edges of a plurality of studs into alignment for the proper installation of drywall panels without the panels becoming bowed outwardly at the middle. Although the hammer and chisel may be used for this purpose, they too are laborious and time consuming, and require a high degree of skill.

It has been found by the present inventor that none of the prior art apparatus and methods provide an effective means of shaving small amounts of wood stock from a door, frame or other work piece as may be required for small adjustments in thickness.

### DISCLOSURE OF INVENTION

It is, therefore, an object of the present invention to overcome or substantially ameliorate the disadvantages and problems of the aforementioned prior art, or at least provide a useful alternative.

It is another object of the present invention to provide a hand held, electrically powered, wood planer for shaving wood stock of, say, 15 to 20 mm thickness from a wooden structure that may be located in a confined space or near an obstruction in a room under renovation or construction,

It has been found by the present inventor that these and other objects of the invention may be achieved in general by providing a hand held, electrically powered, wood planer for shaving small amounts of wood stock from a work piece, comprising a housing in which is located an electric motor and a cylindrical planing tool rotatably mounted for rotation about a horizontal axis, the planing tool being supplied with power from the motor to cause its rotation, and having a minor portion which projects from an opening of the housing so that, in use, the minor portion of the planing tool can impinge on a work piece located in a confined space and, with numerous passes against the work piece, can shave a required thickness of the wood stock, and further comprising means for adjusting the distance to which the minor portion of the planing tool projects from the opening for varying the required thickness of shaved wood stock.

Preferably, the distance adjusting means comprises a height adjustable base of the housing.

The height adjustable base is preferably operable by a control member located at or near a rear end of the planer.

In a preferred form, the control member is a manually controllable knob.

It is preferred that a front end of the housing includes an outlet for the wood stock shaved from the work piece.

The outlet is preferably a shavings compartment that can be opened to allow access to the shaved wood stock for disposal, and can be closed for use of the wood planar.

The planer preferably includes a handle at a top side of the housing, and a trigger for operating the motor is located on an underside of a rear end of the handle.

It is further preferred that the cylindrical planing tool has a substantially smaller diameter than that of conventional planers, and is suited to shaving approximately 15 to 20 mm of thickness of the wood stock.

There has been thus outlined, rather broadly, the more important features of the invention in order that the detailed description thereof that follows may be better understood and put into practical effect, and in order that the present contribution to the art may be better appreciated.

There are additional features of the invention that will be described hereinafter. As such, those skilled in the art will appreciate that the conception, upon which the disclosure is based, may be readily utilized as the basis for designing other assemblies and processes for carrying out the objects of the present invention. It is important, therefore, that the broad outline of the invention described above be regarded as including such equivalent constructions in so far as they do not depart from the spirit and scope of the present invention.

### BRIEF DESCRIPTION OF THE DRAWINGS

The invention will be better understood and objects other than those set forth above will become apparent when consideration is given to the following detailed description thereof. Such description makes reference to the accompanying drawings, in which:

FIG. 1 is a side view of a wood planer according to the prior art,

FIG. 2 is a side view of a hand held, electrically powered, wood planer according to a preferred embodiment of the invention, and

FIG. 3 is a bottom view of the wood planer shown in FIG. 2.

### MODES FOR CARRYING OUT THE INVENTION

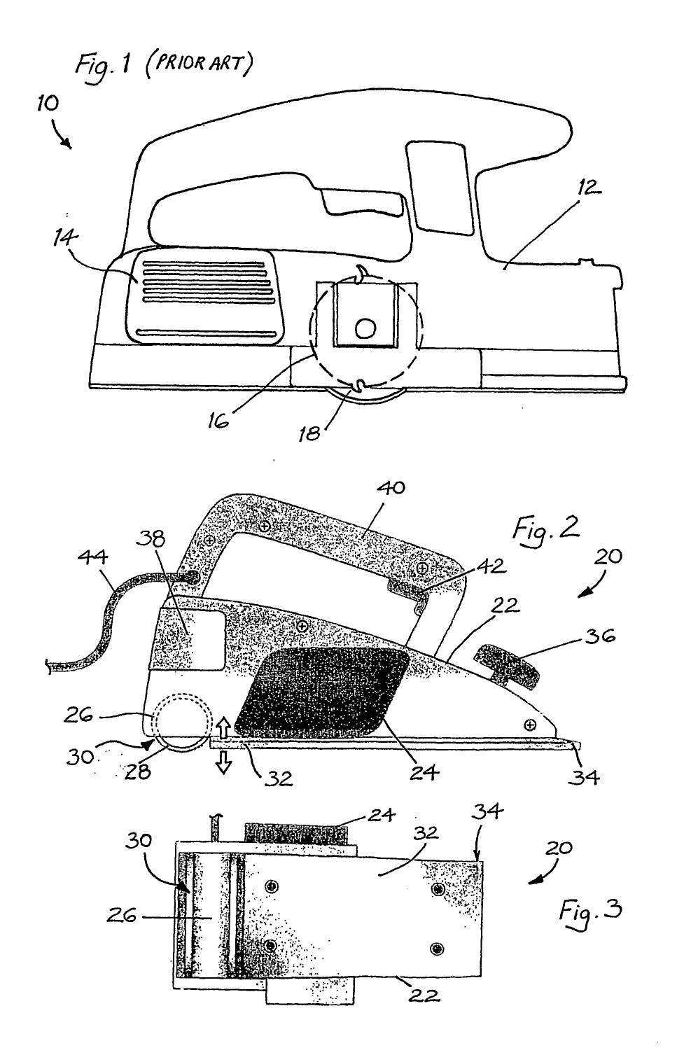

With reference now to the above summarized drawings of FIGS. 1, 2 and 3, both a wood planer of the prior art 10 and a hand held, electrically powered, wood planer embodying the principles and concepts of the present invention and generally designated by the reference numeral 20 will now be described.

The prior art wood planer 10 has a housing in which is located an electric motor (exterior vent cover 14 shown only) and a major portion of a cylindrical rotatable planing tool 16 (hidden outline shown in broken line) to which power can be transmitted from the motor. A rectangular opening is provided at the bottom of the housing near the middle of the planer for allowing a minor portion 18 of the planing tool to project therefrom and, in use, to impinge on a wooden structure or work piece, such as a door.

The planer 10 is held in a manner, when operated, whereby the tool 16 rotates on a horizontal axis and numerous passes against a work piece are made until a required thickness or amount of wood stock has been shaved or planed away.

The planer 10, however, suffers from the various disadvantages and shortcomings described earlier.

In contrast, the hand held, electrically powered, wood planer 20 does not suffer from these disadvantages and shortcomings when used for shaving small amounts of wood stock from a work piece.

The planer 20 has a housing 22 in which is located an electric motor (interior location shown by numeral 24) and a cylindrical planing tool 26 rotatably mounted for rotation about a horizontal axis. The planing tool 26 has a plurality of fine cutting formations or blade elements and is supplied with power from the motor to cause its rotation. The planing tool 26 has a minor portion 28 which projects from an opening 30 at the base (near the front) of the housing. In use, the minor portion 28 of the planing tool 26 impinges on a work piece located in a confined space and, with numerous passes against the work piece, can shave a required thickness of the wood stock. The planer 20 also has means for adjusting the distance to which the minor portion 28 of the planing tool 26 projects from the opening 30 for varying the required thickness of shaved wood stock.

In the present embodiment, the distance adjusting means is provided by a height adjustable base 32 of the housing 22. The base 32 has a pivot point 34 at a rear end of the planer 20. The base 32 can be adjusted upwardly or downwardly as shown by the arrows in FIG. 2, and is ideally suited to shaving a required thickness of wood from the bottom of a door that is still on its hinges.

The height adjustable base 32 is operable by a control member located near the rear end. In the present embodiment, the control member is a manually controllable knob 36. A user may turn the knob 36 clockwise to adjust the height of the base to suit the gap under the door.

The front end of the housing includes an outlet for the wood stock shaved from the work piece. In the present embodiment, the outlet is a shavings compartment 38 that can be opened to allow access to the shaved wood stock for disposal, and can be closed for use of the wood planar. The shavings compartment is, ideally, removable.

The housing may house several planing tools of varying diameter for use as required.

The planer includes a handle 40 at a top side of the housing, and a trigger 42 for operating the motor is located on an underside of a rear end of the handle. The planer is, in this embodiment, powered via an electric cord 44 from a mains power supply.

In this embodiment, the cylindrical planing tool has a substantially smaller diameter than that of conventional planers, and, in use, can shave approximately 15 to 20 mm of thickness of the wood stock.

It will be readily apparent from the above that there are various advantages of the present invention.

One advantage is that it makes it possible to shave wood off the bottom of a door that is still on its hinges, a result that is brought about by the planer having a height adjustable base to accommodate the clearance under the door. Indeed, the planer of the present invention makes it possible to plane the bottom of a door that sits, when still on its hinges, less than about 25 mm (or about 1 inch) above a floor. No time and effort needs to be spent in removing the door for this purpose, and because the planer of the present invention can be used in confined spaces or near an obstruction, no makeshift methods need to be employed to overcome the space limitations.

It will also be readily apparent to persons skilled in the art that various modifications may be made in details of design and construction of the embodiments of the hand held, electrically powered, wood planer, and in the steps of the process using the planer described above without departing from the scope or ambit of the present invention.

The reference in this specification to any prior publication (or information derived from it), or to any matter which is known, is not, and should not be taken as an acknowledgement or admission or any form of suggestion that that prior publication (or information derived from it) or known matter forms part of the common general knowledge in the field of endeavour to which this specification relates before the filing date of this patent application.

1. A hand held, electrically powered, wood planer for shaving small amounts of wood stock from a work piece, comprising a housing in which is located an electric motor and a cylindrical planing tool rotatably mounted for rotation about a horizontal axis, the planing tool being supplied with power from the motor to cause its rotation, and having a minor portion which projects from an opening of the housing so that, in use, the minor portion of the planing tool can impinge on a work piece located in a confined space and, with numerous passes against the work piece, can shave a required thickness of the wood stock, and further comprising means for adjusting the distance to which the minor portion of the planing tool projects from the opening for varying the required thickness of shaved wood stock.

2. The wood planer of claim 1 wherein the distance adjusting means comprises a height adjustable base of the housing.

3. The wood planer of claim 2 wherein the height adjustable base is operable by a control member located at or near a rear end of the planer.

4. The wood planer of claim 3 wherein the control member is a manually controllable knob.

5. The wood planer of claim 1 wherein a front end of the housing includes an outlet for the wood stock shaved from the work piece.

6. The wood planer of claim 5 wherein the outlet is a shavings compartment that can be opened to allow access to the shaved wood stock for disposal, and can be closed for use of the wood planar.

7. The wood planer of claim 1 further including a handle at a top side of the housing.

8. The wood planer of claim 1 further including a trigger for operating the motor; the trigger being located on an underside of a rear end of the handle.

9. The wood planer of claim 3 wherein the height adjustable base includes a pivot point that is operable by the control member to adjust the height of the base adjacent to the opening in the housing.

10. The wood planer of claim 1 wherein the housing is configured to house a plurality of planing tools of varying diameter for use as required.
